(19) United States
(12) Patent Application Publication
(10) Pub. No.: US 2016/0264011 A1
(43) Pub. Date: Sep. 15, 2016

(54) VEHICLE CHARGING STAND MANAGEMENT SYSTEM

(71) Applicant: AYUDANTE, INC, Tokyo (JP)

(72) Inventors: Hiroshi YASUKAWA, Tokyo (JP); Daisuke ITO, Tokyo (JP); Kiyoshi KURIHARA, Tokyo (JP)

(21) Appl. No.: 15/027,404

(22) PCT Filed: Oct. 2, 2014
(86) PCT No.: PCT/JP2014/076410

§ 371 Date: Apr. 5, 2016

(30) Foreign Application Priority Data
Oct. 8, 2013 (JP) 2013-211147

(51) Int. Cl. B60L 11/18; H04M 1/725; H04M 15/00; H02J 7/00; G06Q 30/02

(52) U.S. Cl. CPC B60L 11/1838; B60L 11/1825; H02J 7/0027; G06Q 30/0229; H04M 15/68; H04M 1/7253; B60L 2230/16; H02J 2007/0096; H02J 2007/0001

(57) ABSTRACT

PROBLEM:

In management system of electric vehicle charging stands, to provide added-value services such as addressing emergency charging needs of the drivers, without overly increasing the complexity of the charging controllers.

SOLUTION:

Charging controllers equipped with an identification tag, mobile phones with an identification tag reader, and a management server of the charging controllers are connected via the network as the system to provided various added-value services without overly increasing the complexity of the charging controllers.

### TECHNICAL FIELD

The present invention relates to a system, method and computer program to give convenience to users of vehicle charging stands for electric vehicles and PHV (Plug-in-Hybrid Vehicles).

### BACKGROUND ART

The number of vehicle charging stands in public places such as shopping malls are increasing, as the electric vehicles and PHV (Plug-in-Hybrid Vehicles) (hereafter, collectively referred to as “electric vehicles”) are gaining popularity.

Electric vehicles usually are charged at home or at permanent parking space at night. It would be probably an emergency, when a driver charges his car way from his home. For example, the drive route is changed at the last minute, or the battery is drained faster than expected because of excessive power usage, aging of the battery or traffic jam.

However, there are currently not enough charging stations, therefore a technology to find an available nearby charging station efficiently is required.

A technology such that a central server manages availability of charging stands and notify a driver via a car navigation device, etc, considering the location of the driver is known (for example, 2003-262525 (JP)).

### (Problems in Prior Arts)

However, when someone goes to the charging station instructed by the navigation device, chances are that someone else already is using that station. It usually take about 30 minutes for a full charge, therefore there would be an unexpected waiting time in this case.

Moreover, since, different from the case of gas filling, it is not necessary to keep watching the vehicle while charging; a driver might leave his vehicle for shopping and so on. If the driver does not return to the vehicle even after charge is finished, the charging slot is occupied for an extended time, forcing the next user in line to wait unnecessarily.

### (Problem in Prior Arts)

It is a known art that a user can reserve a charger specifying the time slot (for example 2013-137641 (JP)).

However, as already stated, since it is hard to know beforehand necessity for an emergency charge and a driver could not arrive at the station on reserved time, reservation system with pre-determined time slot is not quite appropriate. Also, this type of reservation system involves complex system management; therefore it might work for charging facilities in semi-private spaces such as condos, but might not work for charging facilities in public spaces.

### (Need to Simplify Charging Stations)

Current charging devices usually have input and output devices such as buttons and LCD (Liquid Crystal Display). As charging devices become more functionally sophisticated, their input and output devices can become more complex. However, since charging devices are usually installed outdoors and will be used for a long period of time, their mechanical complexity should be kept minimal. Overly complex display devices and input devices should be avoided. This is especially important when charging stations are installed in places where frequent maintenance is difficult. Therefore, in solving the problems of the prior arts, overly complex solution should be avoided.

### SUMMARY OF INVENTION

### Problems to be Solved by the Invention

The present invention aims to address urgent charging needs of electric vehicle drivers and provide other added-value services without making charging stand facilities overly complex.

### Means for Solving the Problems

The present invention solves the above problems by providing an electric vehicle charging system comprising multiple charger controllers, multiple mobile phones, and a management server, wherein: the charger controllers, the mobile phones and the management server are connected to each other via a network, the charger controller comprises an identification tag and a status display and are connected to a charger, the mobile phone comprises an identification tag reader, the management server sends a reservation command to one of the multiple charger controllers, responding to a reservation request sent by one of the mobile phones, the charger controller changes the status display to a reserved status and changes a connected charger to a reserved status, responding to the reservation command, the identification tag reader of the mobile phone reads the identification tag of the charger controller and sends an identifier to the management server, and the management server sends a command to change the status display to a usable status and change the connected charger to a usable status, responding to the identifier sent by the mobile phone, along with a mobile phone, a method and a computer program used in such a system.

Also, the present invention solves the above problems by providing An electric vehicle charging system comprising multiple charger controllers, multiple mobile phones, and a management server, wherein: the multiple charger controllers, the multiple mobile phones, and the management server are connected via a network, the charger controller comprises an identification tag, the mobile phone comprises a message sender, a message receiver and an identification tag reader, the identification tag reader of the first mobile phone sends an identifier obtained from the identification tag of the charging controller to the management server, the management server associates and stores a message address of a user of the first mobile phone and the identifier of the charger controller, a identification tag reader of the second mobile phone sends the identifier obtained from the identification tag of the charging controller to the management server and sends a message, and in response to the said message, the management server forwards the massage to the message address of the user of the first mobile phone along with a mobile phone, a method and a computer program used in such a system.

Also, the present invention solves the above problems by providing An electric vehicle charging system with more than one charger controllers, more than one mobile phones and a management server are connected via a network, the charger controller having an identification tags, the mobile phone having an identification tag reader, wherein: the mobile phone sends a first identifier which it gained by reading an identification tag on the charger controller, the management server associates and stores the first identifier and a second identifier of a user of the mobile phone, the identification tag of the mobile phone reads an identification tag in a store and reads a third identifier and sends the third identifier to the management server, the management server, in response to that, determines if a store identified by the third identifier is one of affiliate stores associated with the charger controller identified by the first identifier, and if the user identified by the second identifier is using the charger connected to the charger controller identified by the second identifier, and stores a benefit-related data associated with the user of the mobile phone, if both conditions are met, along with a mobile phone, a method and a computer program used in such a system.

### Advantageous Effect of the Invention

With the present invention, charging need while driving electric vehicles can be well-served without increasing the complexity of the charging controllers.

Also, with the present invention, a user who wants to use the charging controllers can communicate with another user who are currently using the charging controller anonymously and tentatively without increasing the complexity of the charging controllers.

Moreover, with the present invention, a marketing promotion method is provided, where the one charging his electric vehicle can visit affiliate stores to earn the benefits point, giving him an incentive to use the charging station and giving the service provider an earning opportunities from the stores, without increasing the complexity of the charging controllers.

### BRIEF DESCRIPTION OF DRAWINGS

FIG. 1 This is an overview figure of an embodiment of an electric vehicle charging system of the present invention.

FIG. 2 This is an overview figure showing functional components of a charger controller, a management server, and a mobile phone of the present invention.

FIG. 3 This is an overview figure showing data items managed by a management server of the present invention.

FIG. 4 This is an exemplary process flow to reserve a charging stand of the present invention in an emergency.

FIG. 5 This is an exemplary process flow to communicate to the user currently using the charging station of the present invention anonymously and temporarily.

FIG. 6 This is an exemplary process flow for a user using a charging station of the present invention to earn benefits point from affiliate stores.

### DESCRIPTION OF EMBODIMENTS

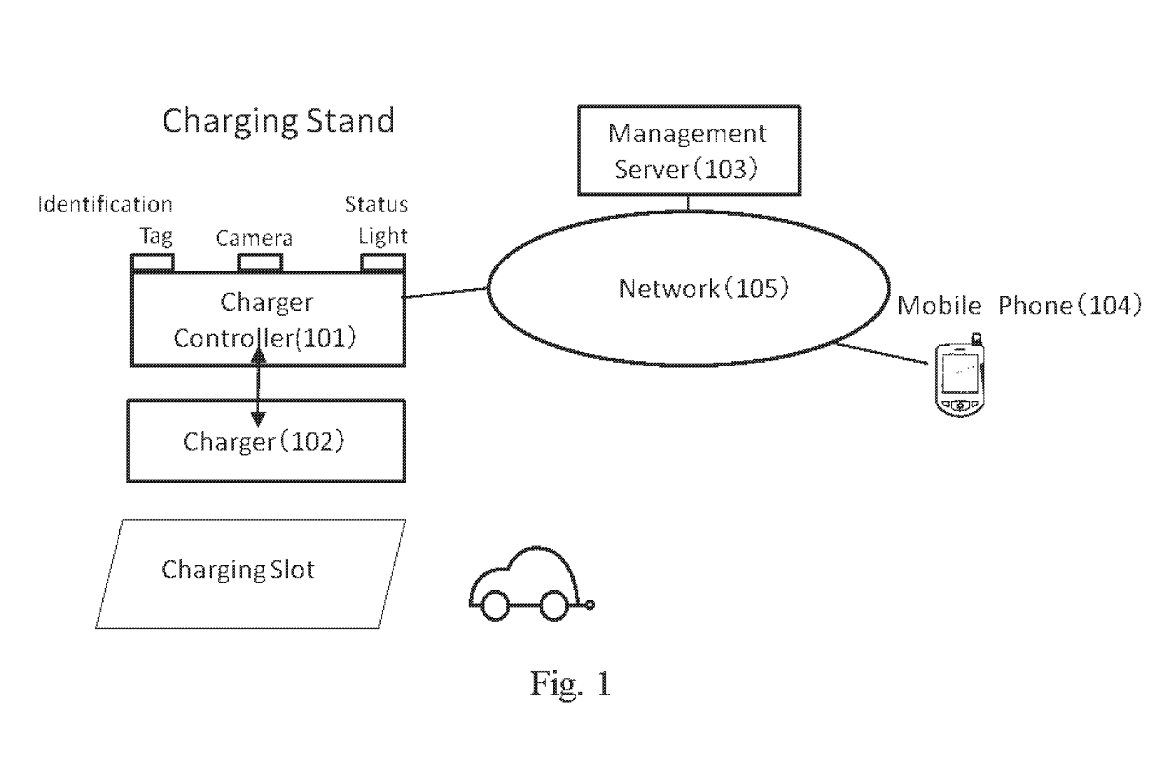

FIG. 1 shows an overview structure of an electric vehicle charging system of the present invention.

### (Components of Charger Controller)

A charging station for electric vehicles has more than one charging slot (charging space). For each charging slot, a Charger 102 and the corresponding Charger Controller 101 are installed. One Charger 102 may serve multiple charging slots.

### (Charger Controller)

Charger Controller 101 comprises of computers connected to Network 105 and programs. Obeying commands sent from Management Server 103 via Network, it controls Charger 102 to start, stop, and inquire status of charging of electric vehicles.

Charger Controller 101 is equipped with an identification tag and a status light. The identification tag is a means for Mobile Phone 104 to uniquely identify Charger Controller 101. The identification tag specifically can be a barcode on the Charger Controller 101 or a RFID inside Charger Controller among others. As an alternative implementation, using communication method such as NFC (Near Field Communication), Bluetooth (trademark), or Wi-Fi (trademark), a program running on Mobile Phone 104 can interact to a program running on Charger Controller 101, and read the identifier of Charger Controller 101.

The status light is a visual means for users to know the status of Charger Controller 101. At least, the status light must be able to show that Charger Controller 101 is reserved and can only be used by the reserving user. In addition, Charger Controller 101 may have a speaker to notify its status with sound signals. Preferably, this notification can be activated only when a vehicle is trying to enter the charging slot. A prior art such as a loop coil, or the camera on the charging controller can recognize that a vehicle is trying to enter the charging slot. In addition to the status light, Charger Controller 101 may have a control mechanism such as a flap to physically prohibit a vehicle to enter the charging slot.

Preferably, Charger Controller 101 might have a camera. Computer programs running on Management Server 103 can recognize if a vehicle occupies the charging slot by analyzing the pictures taken by the camera. Additionally, the pictures taken by the camera may be sent to users' Mobile Phone 104 so that users themselves can see the status of the charging slot. Moreover, by taking a picture of the license plate of the vehicle parked in the charging slot, programs running on Management Server 103 can recognize the license number, determining if the vehicle that reserved the stand is actually using the charging slot.

### (Management Server)

Management Server 103 is an apparatus connected to multiple Charger Controllers 101, and multiple Mobile Phones 104 via Network 105. It usually comprises computer server hardware and related programs.

Management Server 103 stores and manages the location and the properties of each Charger 102, and monitors and manages real-time availability of each Charger via Charger Controller 101. Management Server 103 may know availability of the chargers by inquiring Charging Controller 101 on a request from mobile phones, or it may poll Charging Controller 101 periodically for the status of each charger.

Additionally, as already stated, Management Server 103 may recognize the status of the charging slot using a picture taken by the camera equipped with Charging Controller 101. With this method, a situation where someone is occupying the slot without using Charger 103 can be identified.

### (Mobile Phone)

Mobile Phone 104 is an apparatus used by the driver (user) and typically is a smart phone or a tablet and related programs. Mobile Phone 104 interacts to Management Server 103 via Network 105.

Mobile Phone 104 has a GPS (Global Positioning System) function and a reader of and identification tag of Charger Controller 101. Typically, an identification tag is a 2D barcode, and the identification tag reader is a camera built on the smart phone, but not limited to them.

### (Network)

Network 105 typically is Internet and provides communication between Charger Controller 101 and Management Server 103; and Management Server 103 and Mobile Phone 104 with proven technologies.

### (Functional Components)

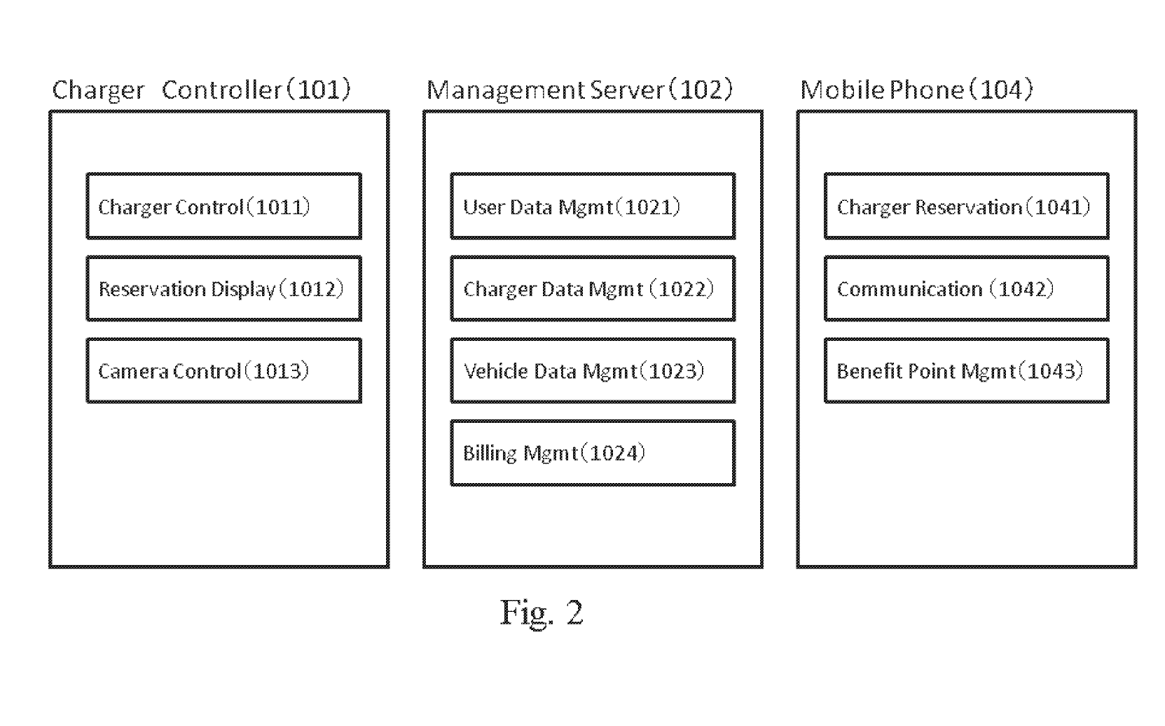

In FIG. 2, functional components of Charger Controller 101. Management Server 103, and Mobile Phone 104 are shown. Each functional component can be implemented by hardware and related programs. These components are logical entities, meaning they are not necessarily bound to a specific hardware. It is a well-known art that functions in other hardware can be accessed via networks. Charging system of the present invention is no exception. In this specification, generic prior-arts such as telecommunication, screen management, and database management will not be explained further.

### (Charger Controller Functional Components)

Charger Controller 101 comprises Charger Control 1011, Reservation Display 1012, and Camera Control 1013.

Charger Control 1011 starts, stops, changes the status of, and reads the status of connected chargers, according commands sent by Management Server 103

Reservation Display 1012 shows that the charger is reserved by means of the status light, a voice message or a physical flap movement.

Camera Control 1013 takes a picture of the charging slot and sends the picture images to the Management Server, instructed by Management Server 103 or programs running on Charging Controller.

### (Management Server Functional Components)

Management Server 101 comprises User Data Management 1021, Charger Data Management 1022, Vehicle Data Management 1023, and Billing Management 1024.

User Data Management 1021 function, Charger Data Management 1022 function, and Vehicle Data Management 1023 function respectively manages user-related data, charger-related data, and vehicle-related data described later.

Billing Management 1024 is a function that manages usage history, fee information and billing process for each user. Preferably, this function may be implemented using an outside service provider that provides credit card transaction processing.

User Data Management 1021 function, Charger Data Management 1022 function, and Vehicle Data Management 1023 function respectively manages user-related data, charger-related data, and vehicle-related data described later.

### (Mobile Phone Functional Components)

Mobile Phone 104 comprises Charger Reservation 1041, Communication 1042, and Benefit Management 1043.

Charger Reservation 1041 comprises a function to inquire Management Server 103 for nearby available charging stands, a function to display nearby charging stands selected by Management Server 103 on a map, and a function to send a command to Management Server 103 in order to make the charging controller selected by the user to a reserved status.

Communication 1042 comprises a function to send and receive mails or messages anonymously and tentatively with the user who leaves his vehicle on the charging slot even after charge is complete.

Benefit Management 1042 comprises a function to display the information of affiliate stores near the charging station currently used, which offer certain benefits under certain business contracts with the charging stand service provider.

### (Databases on Management Server)

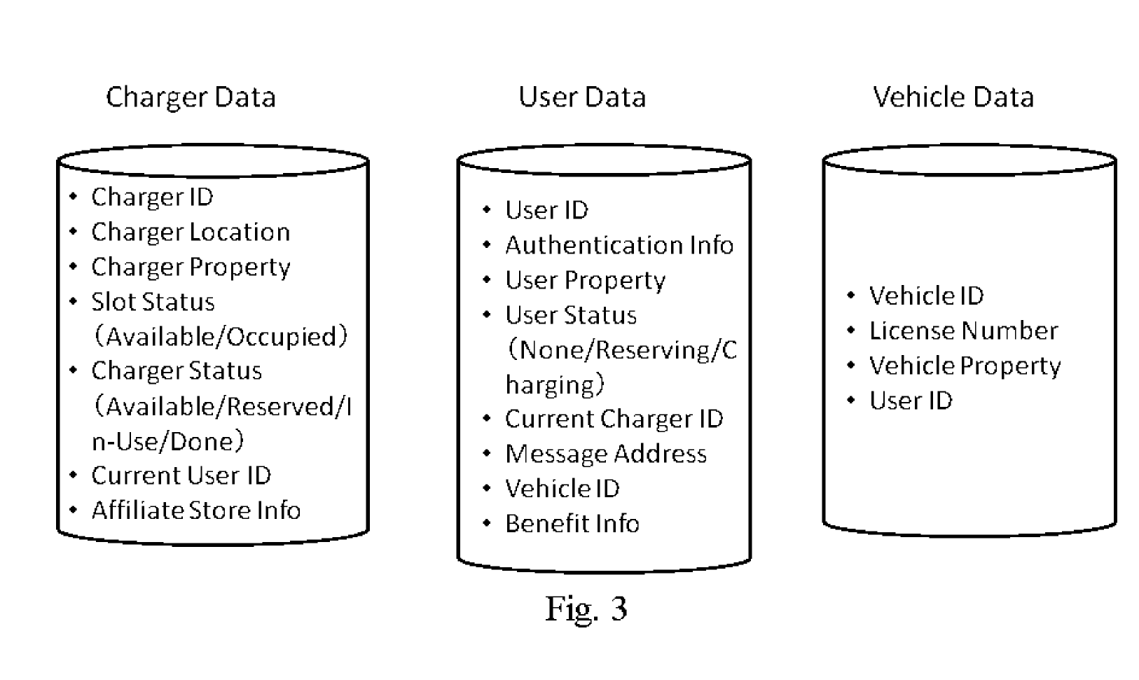

In FIG. 3, data items managed by the databases on Management Server 103 are shown. Management Server 103 manages information on multiple Chargers 102, multiple users and multiple vehicles. Users may register a part of user-related data and vehicle-related data in the databases with predetermined methods, and update it, as necessary. The charging stand system service provider may register a part of charger-related data in the database and update it, as necessary.

### (Charger-Related Data Items)

Management Server 103 manages charger-related data such as Charger ID, Charger Location, Charger Property, Status of the Charging Slot, ID of (using or reserving) User, and Affiliate Stores.

Charger ID uniquely identifies the charger and is the same as the one on the identification tag (typically 2D barcode) associated with the Charging Controller. Location data is about the physical location of the charger. Property is, for example, data about specification of the charger's plug. A system administrator might enter and update location data and property data beforehand.

Charging Slot Status is data about information whether the charging slot is occupied by a vehicle or not. This data can be obtained by Management Server 103 inquiring Charger Controller 101 via Network 105. Alternatively, it can be determined by analyzing the pictures taken by the camera equipped with Charger Controller 101, or any prior art such as a loop coil under the ground.

Charger Status has at least values of “available”, “reserved”, “in-use” and “done”. Management Server 103 can know Charger Status with Management Server 103 inquiring Charger Controller 101 via Network 105 and Charger Controller 101 inquiring the connected Charger in turn.

Current User ID is an identifier of the user who is using the charging station at the point of that time. Affiliate Store Info is data about a name, an address, benefit detail, and an identifier of the nearby stores that would offer benefit to users as a business contract.

### (User Data)

Management Server 103 manages such user-related data as User ID, Authentication Information, Billing Information, User Property, User Status, Current Charger ID, Message Address, and Vehicle ID.

User ID is an identifier that uniquely identifies the user. It is pre-registered with certain agreed procedures. Authentication Information is information to validate the user, such as a password. Validation of users can be done with any prior arts such as passwords or biometrics. Billing Information is data necessary to bill the usage fee to users. Practically, the billing process should be done by outside service providers that offer credit card transaction processing.

User Status is data that shows user is whether “reserving”, “charging”, or “none”, which is dynamically updated by Management Server 103.

Message Address is information is provided in order to send messages and mails to the users, which may be entered at the time of user registration.

Vehicle ID is identifiers of one or more vehicles that the user might use. One user can correspond to multiple vehicles (conversely, multiple users can correspond to one vehicle).

Benefit Info is information about business contacts with affiliate stores. For example, it may be about discount of the charging fees, or other promotional points, which can be arbitrarily determined in business contexts.

### (Vehicle Data)

A charging system of the present invention might manage the chargers not only on per-user basis but also on per-vehicle basis. For example, if multiple users share one vehicle, each user's benefit points may be consolidated. Also it can be used to determine if the vehicle in the charging slot is the one registered with the corresponding users.

Vehicle ID is an identifier that uniquely identifies a vehicle. It may be manually pre-registered by a user, or automatically assigned by a program running on Management Server 103. License Plate Number is self-explanatory.

Vehicle Property is information such as one related with compatibility of charger plugs, which user have registered beforehand. Preferably, when Management Server 103 provides with candidate charging stands on an inquiry from Mobile Phone 104, it may provides with only information of compatible stands.

User ID is/are one or more identifiers of pre-registered users who may use that vehicle. The system may check if User ID of the charging user is associated with the vehicle, but it is necessary to prohibit charging even if the charging user is not associated with the vehicle, because he could borrow the vehicle from someone else and charge it.

### (Process for Emergency Charging Station Reservation)

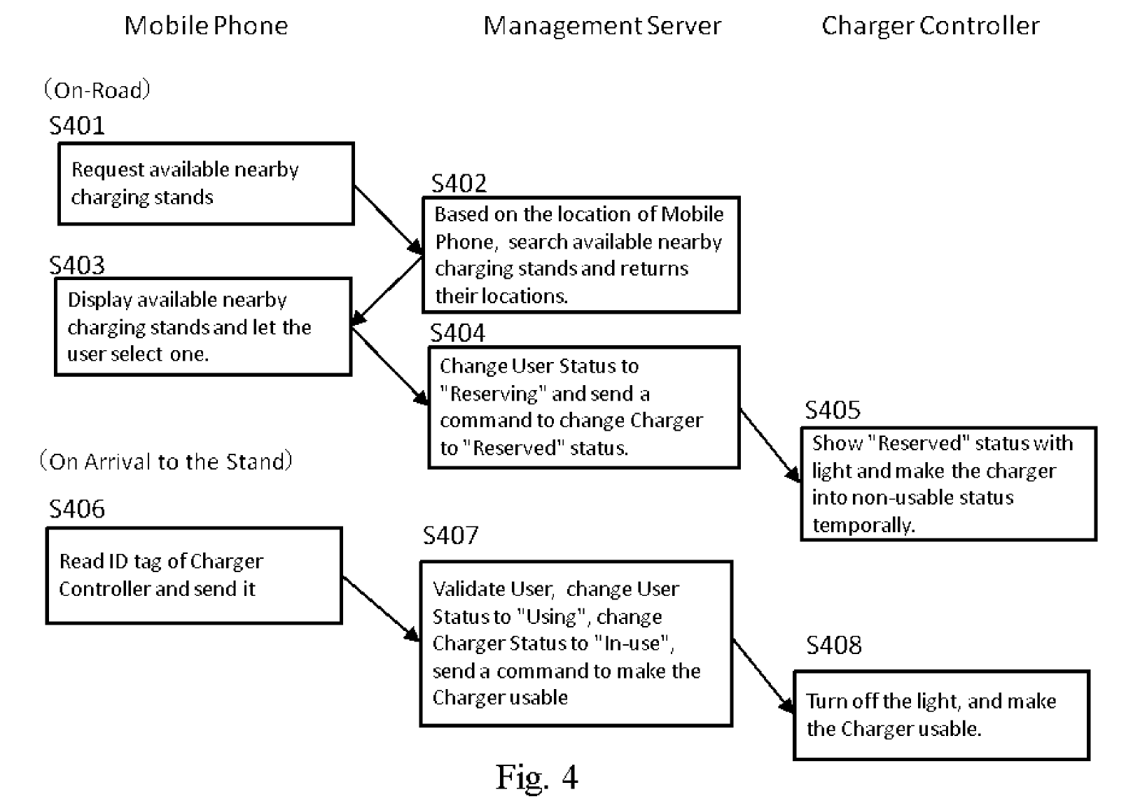

In FIG. 4, a process flow where a user reserves a charging station in emergency and uses it is shown.

(S401) A user who needs a nearby charging station urgently sends a reservation request message including user ID and the current location to Management Server 103 using Mobile Phone 104.

(S402) Management Server 103 returns one or more locations of candidate stations to Mobile Phone 104, judging from the current location of Mobile Phone 104 and status of chargers in the charger database. Here, it is preferable that only compatible charging stands are displayed by comparing charger property in the charger database and vehicle attribute in the vehicle database. In addition, additional information such as the charging fee and nearby facilities (for example, nearby affiliate stores) may also be sent. Moreover, Management Server 103 may determine if a vehicle is present when the charging slot is not used with the camera on Charger Controller 101, and may send a warning message to Mobile Phone 104, if a vehicle is present.

(S403) Mobile Phone 104 displays a candidate list of available nearby charging stations based on the data sent from Management Server 103. Preferably, these stations may be displayed on the map. The user selects one of the stands he wants to use, and Mobile Phone 104 sends that selection to Management Server 103. The user might specify non-emergency mode. Such business contract that a premium fee would be charged for emergency reservation or a penalty is charged for no-show might be enforced in order to prevent overuse of emergency reservations.

(S404) Management Server 103 sends a reservation command to Charger Controller 101 selected by the user and sets Charger Status in the charger database to “reserved”.

(S405) Charger Controller 101, on receipt of the reservation command, sets the connected Charger 102 to unusable temporarily, and turns on the status light to show the charger is available only to the reserving user. In this way, it is ensured that the reserving user can use the charger instantly when he arrives at the station. Additionally, a flap in the charging slot may be raised in order to physically prevent other vehicles to enter the slot.

(S406) When the user arrives at the charging stand he reserved, Mobile Phone 104 reads the identification tag of Charger Controller 101 using a barcode reader (typically, a built-in camera) and sends the identifier of Charger Controller to Management Server 103 along with his User ID.

(S407) Management Server 103 reads the message sent from Mobile Phone 104, and ensures the User ID is the same as the one of the user who reserved that charging controller. If the User ID is the same, Management Server 103 changes the status of the charger database to “in-use”, and sends a command to activate Charger 103. If the user ID sent from Mobile Phone 104 is not same as the one of the user who reserved that charging controller (for example, the user arrives at a wrong charging stand), it is preferable to send an error message to Mobile Phone 104.

(S408) Charger Controller 101, on receipt of the command from Management Server 103, turns off the status light, and makes the connected Charger 102 to “In-Use” status. If the flap is raised to prevent a vehicle to enter the charging slot, it lowers the flap.

When charging is completed, Charger Controller 101, on receiving the status from Charger 102, sends a completion notification to Management Server 103. Management Server 103, in response to the notification, changes the Charger Status to “done”. If the vehicle still occupies the charging slot some time after charging is completed, Management Server 103 may send a warning message to Mobile Phone 104 of that vehicle's user. Also, Charger Controller 101 may produce a warning sound. Such business contract that a premium fee would be charged or a discount would be invalidated for a user who occupies the charging slot for a long time after he completed charging may be agreed beforehand.

### (Anonymous Messaging to Charging Driver)

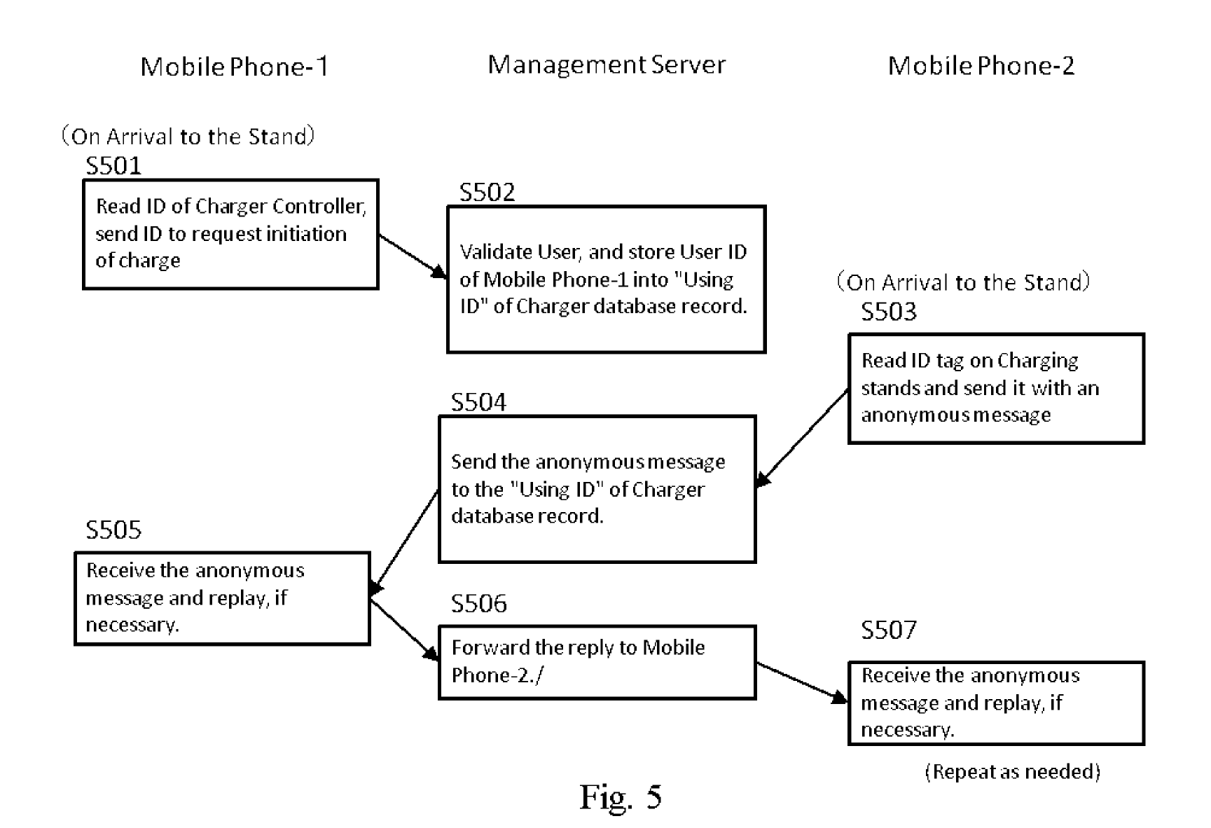

It takes significant time to fully charge an electric vehicle, therefore the driver can leave the vehicle to go to shopping or other activities. In this case, even if charging is completed, the driver might not return to the charging slot, occupying the space for an extended period of time and negatively affecting efficient usage of the chargers and customer satisfaction. This kind of activity can be deterred by a penalty charge. As an additional measure, it is preferable that a user who wants to use the charging slot can communicate to the driver of the occupying vehicle and inquire when the driver would return or urge him to return soon. In this scenario, these two drivers are not acquainted with each other, so it is preferable that their mail addresses or phone numbers are kept anonymous. In addition, their communication is only necessary for a limited time before the driver of the occupying vehicle returns, so it is preferable such anonymous communication is only available for that limited time. In FIG. 5, an exemplary process flow for such anonymous and temporary communication is shown.

(S501) As instructed by User-1, Mobile Phone-1 104 reads the identification tag of Charger Controller 101 and sends the identifier to Management Server 103, along with the ID of User-1. This can be a part of emergency reservation process described earlier or a normal (unreserved) usage.

(S502) Management Server 103 ensures User-1 is a valid user, and stores the ID of User-1 into Current User ID field of the record of the charger database.

(S503) As instructed by User-2, who intends to use the same charger, Mobile Phone 2 reads the identification tag of the charger, and sends ID of User-2 and a message he wants send to the driver of the charging vehicle (that is, User 1) to Management Server 103.

(S504) Management Server 103 ensures that User-2 is a valid user, reads the mail address (or the message address) of the user of Current User ID in the record of the charger database, and sends User-2's message to that address. For User-1 and User-2, each other's phone numbers and message addresses are not known.

(S505) User-1, receiving the anonymous message using Mobile Phone 1, responds back, if necessary. This response is sent by Management Server 103.

(S506) Management Server 103 sends the received response message to Mobile Phone 2 of User-2.

(S507) User 2 can responds to the received message again. This process of sending and receiving messages can be repeated as necessary.

When Management Server 103 recognizes the vehicle of User-1 left the slot (for example, as User 2 (or any other user than User 1) starts using the charging stand, or the camera on Management Server 103 recognizes the vehicle of User-1 left the slot), Management Server 103 terminates the exchange of mails (messages) between User-1 and User-2.

### (Benefit Points of Affiliate Stores)

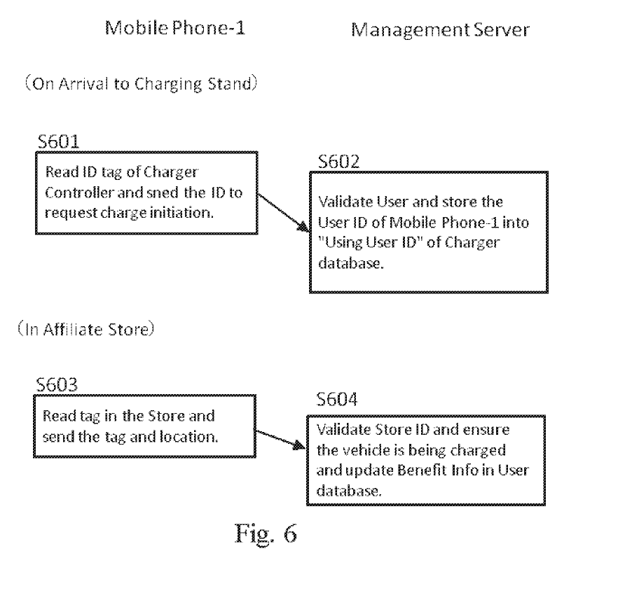

As already stated, a user who charges his vehicles often leaves his vehicle for shopping or dining, and so on. Providing some benefit program for using affiliate stores can be an incentive to use that charging station. Also, charging the fee from affiliate stores, the charging stand business can be more profitable. In addition to that, in this scheme of benefit points, situations where users occupy the charging slot for a long time after the charge is completed. In FIG. 6, a process flow of gaining benefit points from affiliate stores is shown.

(S601) As instructed by a user, Mobile Phone 104 reads the identification tag on the Charger Controller 101, and sends the identifier and the user ID to Management Server 103. This can be either a part of the previously stated emergency reservation process or a use without reservation.

(S602) Management Server 103 checks if the user is an authorized user and save its user ID in Current User ID in the record of the charger database.

(S603) In the affiliate store, as instructed by the user, Mobile Phone 104 reads an identification tag in the store, and sends the identification and user ID to Management Server 103. Here, the identification tag might be 2D barcode or RFID. As a predetermined business rule, the user may scan the identification tag just by visiting store or he may scan the id only if shopping total is more than pre-determined amount or he buys specified items.

(S604) Management Server 103 checks if the identification tag of the store is the one of the affiliate stores and the user is authorized user and he is currently using the charger, and starts benefit granting process. The benefits can be discount of the charging fee and other bonus points. In addition, the location of Mobile Phone 104 can be checked if it is reasonably near to the store. This can prevent a fraud where one photocopies a 2D barcode and get a benefit without actually going to the store. Moreover, Management Server 103 can check the charging status of the vehicle of the visiting user, and, if the visit or purchase is after charging is already completed, it may not give benefit or may give lower benefit than usual. With this scheme, a user has an incentive not to occupy the charging slot for an extend period of time, contributing to higher use efficiency of the charging stand. Moreover, such business rules that benefits are only granted for the visit soon after the start of charging, or benefits vary depending on the time between the start of charging and store visit. may be enforced as an incentive to earlier visit to the store (that is, shorter occupation of the charging slot).

### (Significant Technology Advantage of the Present Invention)

With the present invention, high added-value electric vehicle charging systems can be provided without complex input/output devices on the charging controller. Firstly, drivers of electric vehicle can handle urgent charging need quickly and reliably. Secondly, situations where a vehicle occupies the charging slot unnecessarily after the charge is completed can be minimized. Even if such situation arises, drivers can communicate to each other safely and anonymously. Moreover, providing shopping promotion program associated with vehicle charging can be an incentive for drivers to participate in membership of this charging system, and also prevent situations charging slots are occupied for a long period time even after the charge is completed.

In attaining above merits, the charging controller of the present invention does not have to be complex to manufacture and maintain, and can be reliable even when installed outdoors. Also, most functions are performed in application programs on smart phones and on the management server, new functionality can be added easily without updating the charging controllers.

1. An electric vehicle charging system comprising multiple charger controllers, multiple mobile phones, and a management server, wherein:
the charger controllers, the mobile phones and the management server are connected to each other via a network,
the charger controller comprises an identification tag and a status display and are connected to a charger,
the mobile phone comprises an identification tag reader,
the management server sends a reservation command to one of the multiple charger controllers, responding to a reservation request sent by one of the mobile phones,
the charger controller changes the status display to a reserved status and changes a connected charger to a reserved status, responding to the reservation command,
the identification tag reader of the mobile phone reads the identification tag of the charger controller and sends an identifier to the management server, and
the management server sends a command to change the status display to a usable status and change the connected charger to a usable status, responding to the identifier sent by the mobile phone.

2. A mobile phone used in an electric vehicle charging system comprising:
a means for sending a reservation command to a management server,
a means for having the management server send a reservation request to a charger controller specified in the reservation command,
a means for having charger controller to display a reserved status, and stopping a charger connected to the charger controller; and
a means for sending an identifier obtained from the identification tag on the charger controller and having the management server send a reservation command to the charger controller specified in the reservation request,
a means for having the reservation controller which receives the reservation command turn on a status light to show a reserved status and stop a connected charger,
a means for sending an identifier obtained by reading the identification tag on the charger controller to the management server, and
a means for having the management server send a command to the charger controller to turn off the status light and start the connected charger.

3. A computer program used in an electric vehicle charging system comprising:
instructions for sending a reservation command to one of multiple charger controllers, responding to a reservation request from a mobile phone,
instructions for having the charger controller that received the reservation command make a reservation display to reserved status and stop a connected charger,
instructions for sending an identifier of the charger controller obtained by an identification tag reader of the mobile phones,
instructions for sending a command to make the reservation display to an unreserved status and start the connected charger.

4. A method executed by a computer to manage an electric vehicle charging system comprising:
a step of sending a reservation command to one of multiple charging controllers based on a command request sent from a mobile phone,
a step of stopping a charger connected to the charger controller which receives the reservation command and turning on a light on the charger to show a reserved status,
a step of sending an identifier obtained by an identification tag reader of the mobile phone reading an identification tag on the charger controller, and
a step of sending a command to the charger controller to turn off the light and start the charger.

5. An electric vehicle charging system comprising multiple charger controllers, multiple mobile phones, and a management server, wherein:
the multiple charger controllers, the multiple mobile phones, and the management server are connected via a network,
the charger controller comprises an identification tag,
the mobile phone comprises a message sender, a message receiver and an identification tag reader,
the identification tag reader of the first mobile phone sends an identifier obtained from the identification tag of the charging controller to the management server,
the management server associates and stores a message address of a user of the first mobile phone and the identifier of the charger controller,
a identification tag reader of the second mobile phone sends the identifier obtained from the identification tag of the charging controller to the management server and sends a message, and
in response to the said message, the management server forwards the massage to the message address of the user of the first mobile phone.

6. Mobile phone used in an electric vehicle charging system, comprising:
a means for sending an identifier which was obtained by reading identification tag on a charger controller,
a means for having a management server associate and store a message address of a user of a mobile phone and the identifier of the charger controller, and
a means for receiving a message sent to the massage address stored by the management server, as other mobile phones send an identifier obtained by reading the identification tag of the charger controller and a message.

7. A computer program to manage an electric vehicle charging system, comprising:
instructions for an identification tag reader of a first mobile phone reading an identification tag of a charger controller,
instruction for associating and storing a message address of a user of the first mobile phone and the identifier,
instructions for an identification tag reader of a second mobile phone reading the identification tag of the charger controller,
instructions for receiving a message sent from a second mobile phone,
instructions for sending the message to the message address of the user of the first mobile phone.

8. A method executed by a computer to manage and electric vehicle charging system, comprising:
a step of an identification tag reader of a first mobile phone reading an identification tag of a charger controller,
a step of sending an identifier of the charger controller identified by the identification tag,
a step of associating and storing a message address of a user of the first mobile phone and the identifier,
a step of an identification tag reader of a second mobile phone reading an identification tag of the charger controller, and
a step of forwarding a message sent from the second mobile phone to the message address of the user of the first mobile phone.

9. An electric vehicle charging system with more than one charger controllers, more than one mobile phones and a management server are connected via a network, the charger controller having an identification tags,
the mobile phone having an identification tag reader, wherein:
the mobile phone sends a first identifier which it gained by reading an identification tag on the charger controller,
the management server associates and stores the first identifier and a second identifier of a user of the mobile phone,
the identification tag of the mobile phone reads an identification tag in a store and reads a third identifier and sends the third identifier to the management server,
the management server, in response to that, determines if a store identified by the third identifier is one of affiliate stores associated with the charger controller identified by the first identifier, and if the user identified by the second identifier is using the charger connected to the charger controller identified by the second identifier, and stores a benefit-related data associated with the user of the mobile phone, if both conditions are met.

10. A mobile phone used in an electric vehicle charging system comprising:
a means of sending a first identifier identifying a charger to a management server, wherein the first identifier is gained by reading an identification tag on the charger,
a means of letting the management server associate and store the first identifier and a second identifier identifying a user of the mobile phone,
a means of sending a third identifier which was gained by reading an identification tag in the store to the management server, letting the management server determine if the store identified by the third identifier is one of affiliate stores associated with the charger controller identified by the first identifier, and if the user identified by the second identifier is using the charger connected to the charger controller identified by the first identifier, and
a means of associating and storing information about the user of the mobile phone and information about a benefit, if both conditions are met.

11. A computer program to manage an electric vehicle charging system comprising:
instructions of receiving an identifier of a charger which a mobile phone sends, an instructions of associating and storing a first identifier of the charger and a second identifier of a user of the mobile phone,
instructions of receiving a third identifier of identification tag in a store which the mobile phone sends, and
identifier of associating and storing information about the user of the mobile phone and information about a benefit, if both conditions are met.

12. A method executed by a computer to manage an electric vehicle charging system comprising:
a step of receiving an identifier of a charger which a mobile phone sends,
a step of associating and storing a first identifier of the charger and a second identifier of a user of the mobile phone,
a step of receiving a third identifier of identification tag in a store which the mobile phone sends,
a step of determining if the store identified by the third identifier is one of affiliate stores associated with the charger controller identified by the first identifier, and if the user identified by the second identifier is using the charger connected to the charger controller identified by the first identifier, and
a step of associating and storing information about the user of the mobile phone and information about a benefit, if both conditions are met.
